(19) United States
(12) Patent Application Publication
(10) Pub. No.: US 2014/0233055 A1
(43) Pub. Date: Aug. 21, 2014

(54) METHOD, DEVICE AND COMPUTER READABLE MEDIUM FOR MANAGING PRINT JOBS

(71) Applicants: Ori Eizenberg, Tel Aviv (IL); Yishai Brafman, Tel Aviv (IL); Boaz Katz, Kfar Saba (IL)

(72) Inventors: Ori Eizenberg, Tel Aviv (IL); Yishai Brafman, Tel Aviv (IL); Boaz Katz, Kfar Saba (IL)

(21) Appl. No.: 13/769,849

(22) Filed: Feb. 19, 2013

(51) Int. Cl. G06F 3/12

(52) U.S. Cl. CPC G06F 3/1296
USPC 358/1.15

(57) ABSTRACT

A method for managing a print job, the method may include intercepting, by a computerized module, a request to print a print job content by a target printer; analyzing, by the computerized module, the print job content to determine an expected printing cost of the print job content by the target printer; selecting, by the computerized module, a selected printer to print the print job content, out of the target printer and another printer, in response to the expected printing cost; and sending the print job content information to the selected printer.

### FIELD OF THE INVENTION

This invention relates to methods, systems and computer readable mediums for managing print jobs.

### BACKGROUND OF THE INVENTION

Many computerized systems include one or more computers that are connected over a network to one or more printers.

When there is a need to print content a computer sends a print job to a target printer. The print job includes a target printer identifier and print job content that should be printed by the target printer. The print job content may include text, graphics and/or images.

The computer that generates the print job (and selects the target printer) is unaware to various considerations such as the cost of the printing of the print job content, as well as to various security related considerations and thus the printing job can be executed in an inefficient manner or may even be executed without permission.

There is a growing need to manage print jobs in a cost effective and a secure manner.

### SUMMARY OF THE INVENTION

The invention provides a method, device and computer readable medium for managing print jobs as disclosed in the specification and, additionally or alternatively as disclosed in the claims.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 illustrates a method according to an embodiment of the invention;

FIGS. 2 and 3 illustrate methods for estimating an area of a text symbol to be printed according to various embodiments of the invention;

FIG. 4 illustrate a first page and a second page that belong to a print job;

FIG. 5 illustrates a layout of the first and second pages according to an embodiment of the invention;

FIG. 6 illustrates a layout of an amended page that includes the content of the first and second pages according to an embodiment of the invention;

FIG. 7 illustrates a layout of an amended first page that excludes a first symbol of the first page according to an embodiment of the invention;

FIG. 8 illustrates a layout of an amended first page that includes an amended first image instead of a first image according to an embodiment of the invention;

FIG. 9 illustrates a method according to an embodiment of the invention;

FIG. 10 illustrates a method according to an embodiment of the invention;

FIG. 11 illustrates a method according to an embodiment of the invention; and

FIG. 12 illustrate a system and its environment according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Any reference in the specification to a system should be applied mutatis mutandis to a method that can be executed by the system.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

The term “computer” refers to any type of computerized device including, but not limited to, desktop computers, servers, laptop computer, mobile devices, digital cameras, cellular phones, personal data accessories and the like.

The term “computerized module” refers to a computerized entity that may be a computer, a portion of the computer (such as a processor) or an entity that is being hosted by a computer or a portion of a computer.

The term “multiple pixel entity” may be regarded as any entity of a page that includes multiple pixels—especially more than one hundred pixels. It may be one or more text lines, graphics, a combination of one or more graphic symbols, an image, a portion of an image, a header, a footer, and the like.

There are provided systems, methods and non-transitory computer readable media for managing print jobs contents.

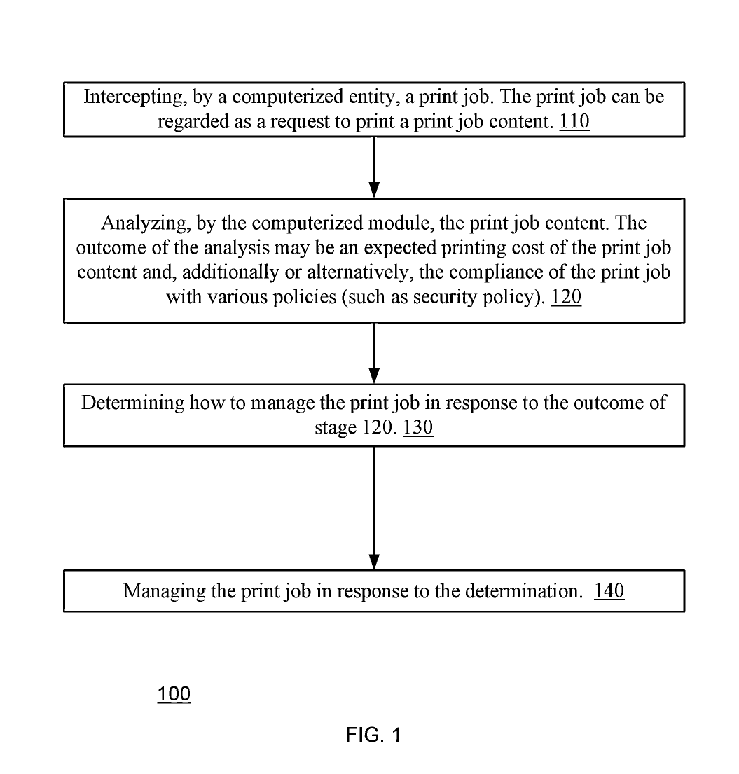

FIG. 1 illustrates method 100 according to an embodiment of the invention.

Method 100 may start by stage 110 of intercepting, by a computerized entity such as an intercepting module, a print job. The print job can be regarded as a request to print a print job content.

The intercepting occurs before the print job is printed. The interception can occur at any stage after the print job is initiated by an application and before it reaches the target printer.

The intercepting may be executed by any manner such as but not limited to (depending on the Operating System of the computer that sent the print job and printing architecture: (a) Application Hooking—Intercepting GDI Calls and/or Redirect to virtual printer, (b) Spooler—Intercept stream before/after spooling, Intercept spool file before/after spooling, Process using Filter in Pipeline or chain before/after spooling

Stage 110 may be followed by stage 120 of analyzing, by the computerized module such as an analyzer, the print job content. The outcome of the analysis may be an expected printing cost of the print job content and, additionally or alternatively, the compliance of the print job with various policies (such as security policy).

If the intercepting includes redirecting the print job to the virtual printer the virtual printer may generate an intermediate file that represents the print job (including its content) at an intermediate format (we use EMF, postscript and XPS). Stage 120 may include analyzing the intermediate file.

If the print job includes a target printer (to be used to print the print job content) then the expected printing cost of the print job content is calculated taking into account the expected printing cot by the target printer. The cost of printing the print job content by one or more other printers may also be calculated.

Depending on the selected interception method and OS the intercepted stream or spool file can contain any DPL or intermediate format (EMF, XPS, Postscript, PCL, Image, Text . . . ) or by rasterizing the text element and inspecting each pixel value.

The analysis includes analyzing the intermediate format.

Stage 120 may include analyzing the print job to determine a layout, text, image content and coverage of the print job content. The determination may be separates by element type (Image, Text or Graphics) and color composition (Black, Grayscale and Color).

The analysis of graphics may include, for example, calculating the bounding box of the graphic element, mapped to the physical output, according to its shape (Rectangle, ellipse, line, polygon) and determining the coverage area either by calculating the relative object to bounding box ratio or by rasterizing the graphic element and inspecting each pixel value.

The analysis of text may include, for example, calculating the bounding box of the text element (black box), mapped to the physical output, according to the font characteristics and color to determining the coverage area either by calculating the relative glyph size to bounding box ratio.

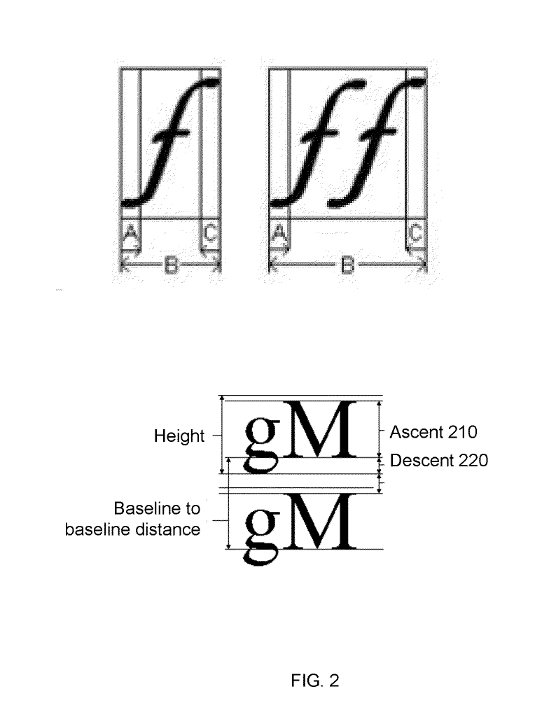

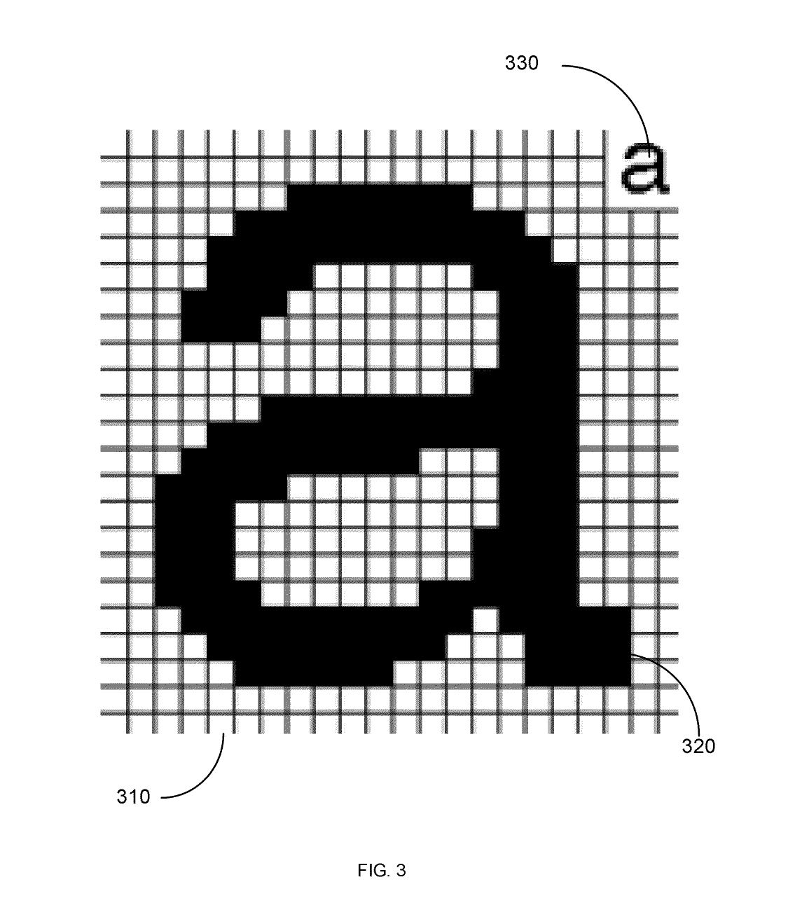

FIGS. 2 and 3 illustrate methods for estimating an area of a graphic symbol to be printed according to various embodiments of the invention. FIG. 2 illustrates a calculation of a bounding box of various characters.

The area of a character is calculated while taking into account an origin point, a baseline, a width (denoted B) that defines how the charter are place in a string, left and right baring (denoted A and C) that specify if and how a character exceeds the width in each direction, decent (210) and accent (220) from baseline and a black box bounding box.

So if you just need to calculate one character you could use the bounding box of the single character.

When the area of a string of characters has to be evaluated (for example AfC) There is a need to take into account the relationship between the characters: A width+A left baring+f width+C with+C right baring. When the characters are not horizontally aligned there is a need to calculate the height you need to take into account both accent and decent.

FIG. 3 illustrate a text symbol “a” 320 that is mapped to a dense grid 310 of sub-pixels and its area is calculated by counting the number of grid elements that are “covered” by the text symbol.

The analysis of an image may include, for example, mapping the image to physical output and inspecting each pixel value.

The analysis of layout of each page of the print job content may include, for example, mapping each page layout by the elements bounding boxes and identifying the elements location and whitespace.

The analysis of coverage of each page may include, for example, breaking down each page to its core elements and calculates its mono and color coverage by inspecting each pixels color composition, taking into account the output media size, the printable area and the printer and driver characteristics to determine the mapping of each virtual pixel to the actual pixel size.

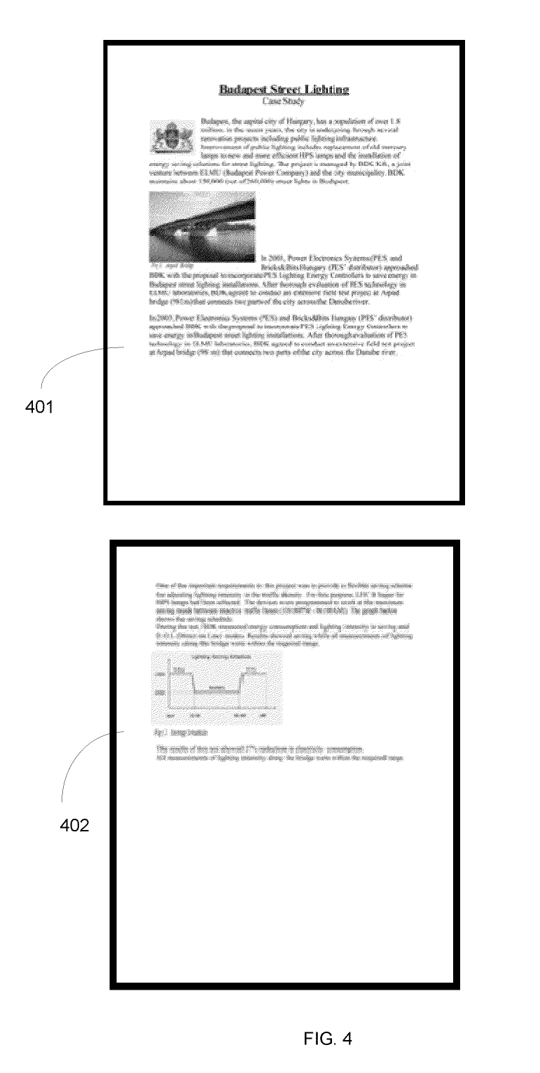

FIG. 4 illustrate a first page 41 and a second page 42 that belong to a certain print job.

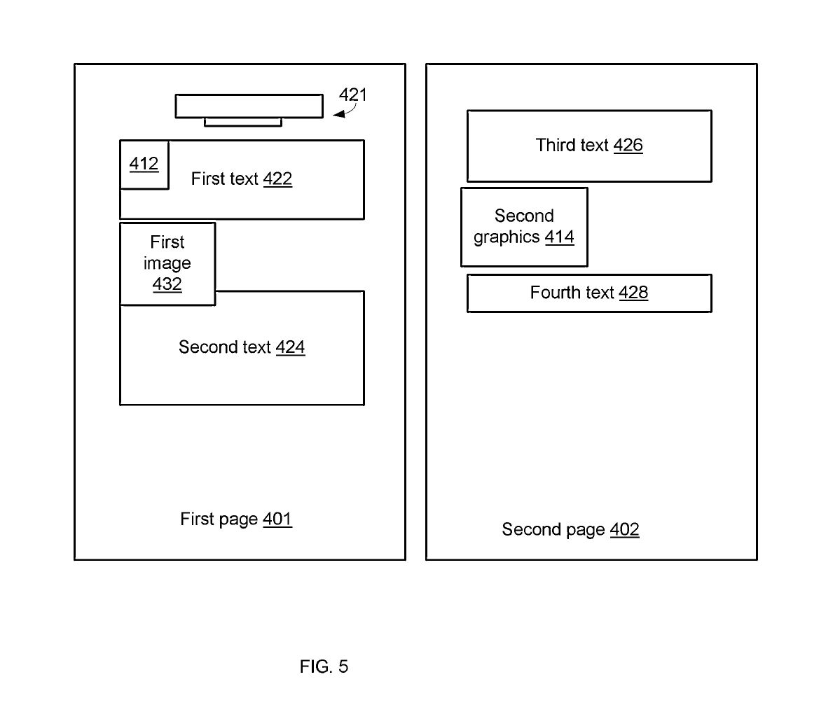

FIG. 5 illustrates the layout of the first and second pages 41 and 42 according to an embodiment of the invention—including their core elements.

The first page 41 includes: (a) text elements such as title and sub-title 421, first text 422 and second text 424, (b) first graphics 412 and (c) first image 432. The first text 422 partially surrounds first graphics 412 and is positioned above first image 432. The lower edge and a small part of the right edge of first image 432 interface with the upper left part of second text 424.

The second page 41 includes: (a) text elements such third text 426 and fourth text 428, and (b) second graphics 414. Second graphics 414 is positioned between the third text 426 and the fourth text 428.

Stage 120 may be followed by stage 130 of determining how to manage the print job in response to the outcome of stage 120. The determining can be performed by a computerized entity such as a decision module.

For example, stage 130 may include determining how to manage the print job in response to the expected cost of printing the print job content, and/or in response to one or more security or permission rule.

Stage 130 may be followed by stage 140 of managing the print job in response to the determination. The determining can be performed by a computerized entity such as a decision module.

Stage 140 may include sending the print job content to a printer that differs from the target printer, sending the print job to the target printer, changing the content of the print job—changing the way the print job is to printed, converting the print job to a digital file, applying consumable savings, creating alert to a specific user or function, preventing the printing of the print job content and the like.

Stage 140 may include managing the intermediate file if such file was generated during stage 120. This stage may include recomposing automatically the intermediate file, blocking the intermediate file from being printed, allowing a user to edit the intermediate file, apply saving when printing the intermediate file, generating a digital document for archiving or send by email, print to original printer or redirect The rule set engine can determine its course of action according to the statistics collected while printing to the virtual printer (user, printer, application, document name, key words, color/mono pages, coverage, cost . . . ).

Stage 140 may include sending the print job to an archive, requesting from an administrator a permission to print the print job, sending an alert about the print job to an administrator. An administrator is an entity that is authorized to manage the printing scheme, authorize printing jobs and the like. These stages can be taken if determined to do so during stage 130.

Stage 140 may include further processing the intermediate file (is such a file was generated) and convert the intermediate file into readable/portable format (PDF, XPS) according to the statistic (mainly key words and document name). Stage 140 may include archiving the intermediate file, and the like. These stages can be taken if determined to do so during stage 130.

The applying of consumable savings can include applying the method illustrated in U.S. Pat. No. 8,284,446 that is incorporated herein by reference.

Stage 130 may be executed by a rule set engine. The rule set can create a single or a series of actions.

Stage 130 may include receiving the coverage, color and layout data and determining how to manage the print job based on the documents statistics: Printing application, User permissions, Key words, Output printer type color/mono, Cost per page/job, Total coverage per page/job, Mono coverage per page/job, Color coverage per page/job, Image coverage per page/job, Graphic coverage per page/job, Text coverage per page/job.

Stage 130 may include, for example:
a. Determining to redirect the print job to mono printer when (a) Color coverage is less than a predetermined amount (for example—less than 5%), (b) User is not permitted to print in color.
b. Determining to redirect the print job to less costly printer when color coverage is above a predefined amount (for example—over 20%).
c. Determining to request administrator privilege, block print job or send print job to archive when: job is generated by a specific application, job contains specific words—“confidential”, “secret”, “blue print”, job color cost is above a certain cost (for example—about 5$).
d. Determining to suggest a different layout for the user.
e. Determining to remove costly elements—layout—remove header and footers and whitespace from output, layout—remove graphics and image and whitespace from web page to generate readable output.

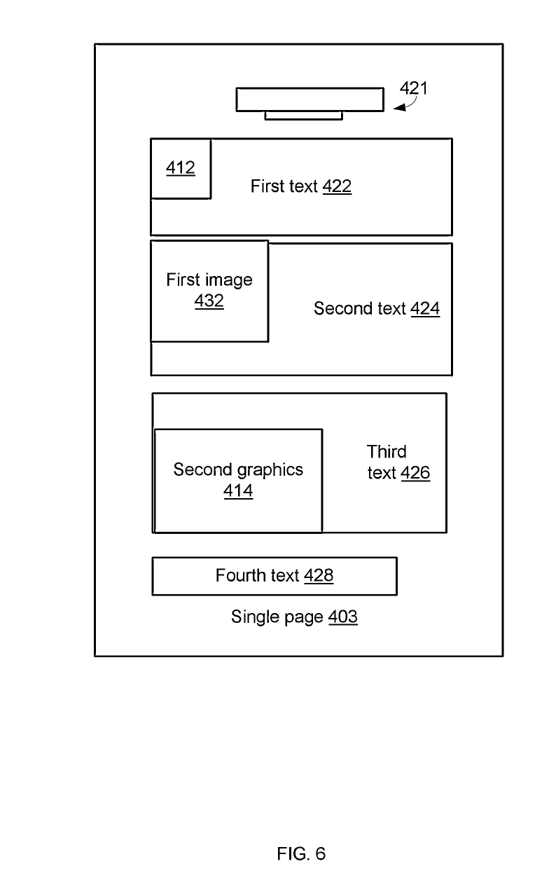

Various examples of changes in a layout of the first and second pages of FIG. 2 are illustrated in FIGS. 6-8.

FIG. 6 illustrates a layout of an amended page 403 that includes the content of the first and second pages 41 and 42 according to an embodiment of the invention.

The amended page 403 includes: (a) text elements such as title and sub-title 421, first text 422, second text 424, (b) first and second graphics 412 and 414, and (c) first image 432.

The spatial relationship between the different multi-pixel elements of each original page changed. For example—while in the first page 41 the upper edge of second text 424 was proximate to the lower edge of the first image 432—in the amended page 403 the upper edges of the second text 424 and the first image 432 are substantially at the same level. Yet for another example—while in the second page 42 the entire third text 426 was above the second graphics 414—in the amended page 403 the second graphics 414 is partially surrounded by the third text 426 and the upper edge of the third text 426 is above the upper edge of the second graphics 414.

The original multi-pixel elements (412, 421, 422, 424 and 432) of the first page are located in the amended page 403 above all the multi-pixel elements (414, 426 and 428) of the second page 42.

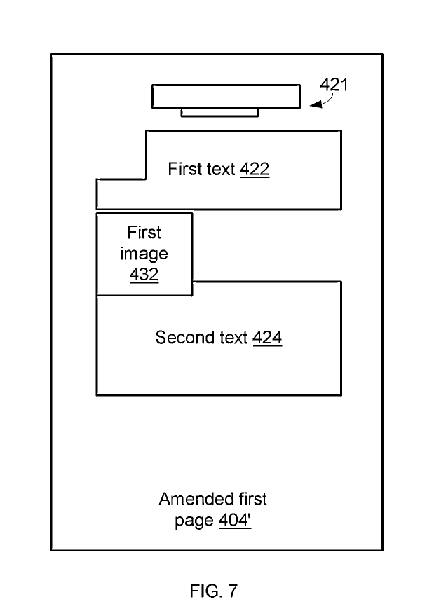

FIG. 7 illustrates a layout of an amended first page 404′ that excludes a first symbol 412 of the first page according to an embodiment of the invention. This first symbol may have been too costly to print and thus was removed.

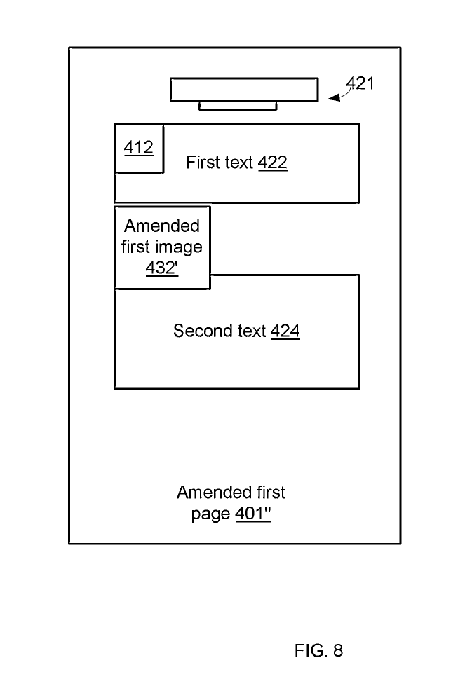

FIG. 8 illustrates a layout of an amended first page 404″ that includes an amended first image 432′ instead of a first image 432 according to an embodiment of the invention. The amended first image 432′ may be a monochromatic and not a color image or may be of a reduce quality—in order to reduce the cost of printing.

Stage 140 may include, for example:
a. Redirecting the print job to mono printer when (a) Color coverage is less than a predetermined amount (for example—less than 5%) (b) User is not permitted to print in color.
b. Redirecting the print job to less costly printer when color coverage is above a predefined amount (for example—over 20%).
c. Requesting administrator privilege, blocking print job or send print job to archive when: job is generated by a specific application, job contains specific words—“confidential”, “secret”, “blue print”, job color cost is above a certain cost (for example—about 5$).
d. Suggesting a different layout for the user.
e. Removing costly elements—layout—removing header and footers and whitespace from output, layout—removing graphics and image and whitespace from web page to generate readable output.

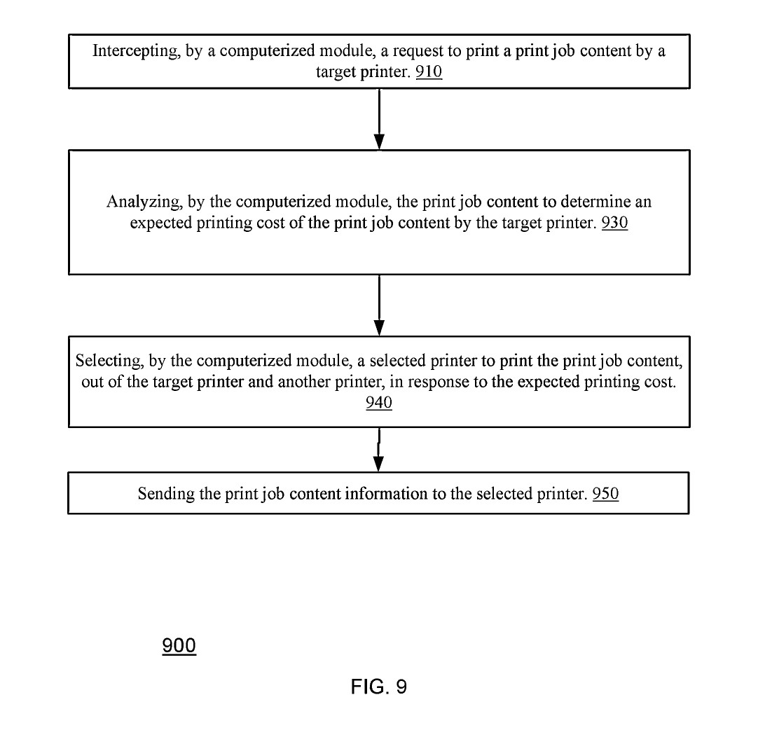

FIG. 9-11 illustrate method 900, 1000 and 1100 according to various embodiments of the invention. These methods illustrate various aspects of method 100.

FIG. 9 illustrates method 900 for managing a print job, according to an embodiment of the invention.

Method 900 may start by stage 910 of intercepting, by a computerized module, a request to print the print job content by a target printer.

Stage 910 may occur before the request reaches the target printer.

Stage 920 may be followed by stage 930 of analyzing, by the computerized module, the print job content to determine an expected printing cost of the print job content by the target printer.

Stage 930 may include at least one out of:
a. Determining a layout of the print job content, types of content and color composition.
b. Calculating a cost for printing each text symbol of the print job content by evaluating a size and shape of the text symbol and a manner in which the target printer is expected to print the text symbol

Stage 930 may be followed by stage 940 of selecting, by the computerized module, a selected printer to print the print job content, out of the target printer and another printer, in response to the expected printing cost.

Stage 940 may be followed by stage 950 of sending the print job content information to the selected printer.

Stage 940 may include at least one of the following:
a. Determining to print the print job content by the other printer if an expected printing cost of the print job content by the other printer is lower than the expected printing cost of the print job content by the target printer. The other printer may be a monochromatic printer and the target printer may be a color printer.
b. Determining, by the computerized module, whether to modify the print job content to provide modified print job content that represents a modified print job content that is expected to be cheaper to print than the print job content. In this case stage 950 may include sending the modified print job content to the selected printer.
c. Determining whether to select a selected printer or to prevent the printing if the expected printing cost of the print job content by the target printer exceeds a cost threshold.
d. Determining whether to select a selected printer or to prevent the printing if an expected printing cost of the print job content by any printer out of the target printer and the other printer exceeds a cost threshold.
e. Determining to send the print job to another printer that is a virtual printer that is arranged to convert the print job content to digital print job content.
f. Selecting a printer in response to statistics of previously printed print job content
g. Preventing the printing of the print job content if detecting a key word that indicates that the document should not be printed.

Stage 940 may be followed by stage 950 of sending the print job content information to the selected printer

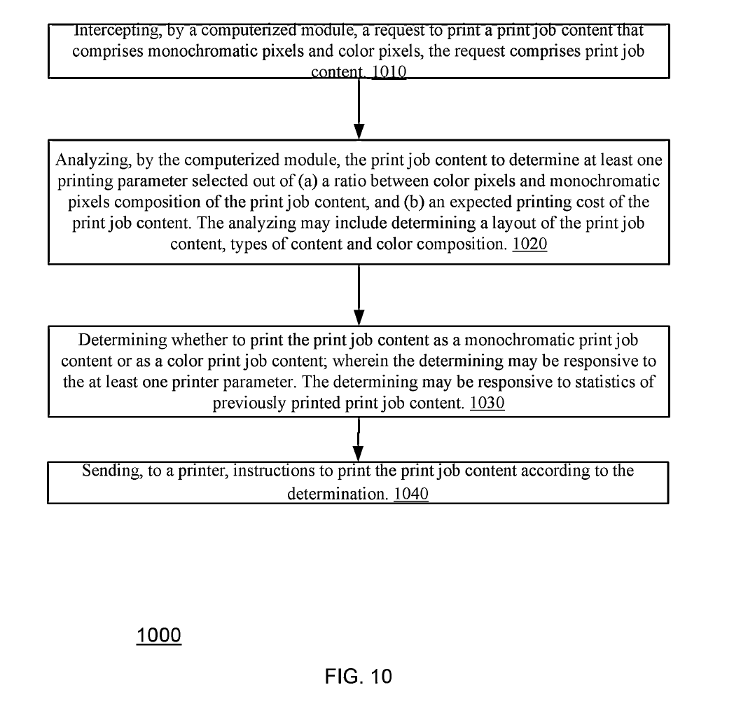

FIG. 10 illustrates method 1000 for managing a print job, according to an embodiment of the invention.

Method 1000 may start by stage 1010 of intercepting, by a computerized module, a request to print a print job content that comprises monochromatic pixels and color pixels, the request comprises print job content.

Stage 1010 may be followed by stage 1020 of analyzing, by the computerized module, the print job content to determine at least one printing parameter selected out of (a) a ratio between color pixels and monochromatic pixels composition of the print job content, and (b) an expected printing cost of the print job content. The analyzing may include determining a layout of the print job content, types of content and color composition.

Stage 1020 may be followed by stage 1030 of determining whether to print the print job content as a monochromatic print job content or as a color print job content; wherein the determining may be responsive to the at least one printer parameter. The determining may be responsive to statistics of previously printed print job content.

Stage 1030 may be followed by stage 1040 of sending, to a printer, instructions to print the print job content according to the determination.

Stage 1040 may include sending the print job content to a monochromatic printer if it is determined to print the print job content as monochromatic print job content and sending the print job content to a color printer if it is determined to print the print job content as a color print job content.

Stage 1030 may include determining to print the print job content as monochromatic print job content if a ratio between monochromatic pixels and determining whether to print the print job content as monochromatic print job content is above a predetermined ratio. The predetermined ratio may be at least 19 (representing a color content of 5% or less).

Stage 1030 may also include modifying the print job content to provide modified print job content that represents modified print job content without at least some of the color pixels of the print job content if it is determined to print the print job content as a monochromatic print job content.

Stage 1030 may also include modifying the print job content to provide modified print job content that represents a modified print job content that lacks at least one multiple-pixel entity of the print job content if it is determined to print the print job content as a monochromatic print job content.

Stage 1030 may include determining to print the print job content by another printer that is a virtual printer arranged to convert the print job content to digital print job content.

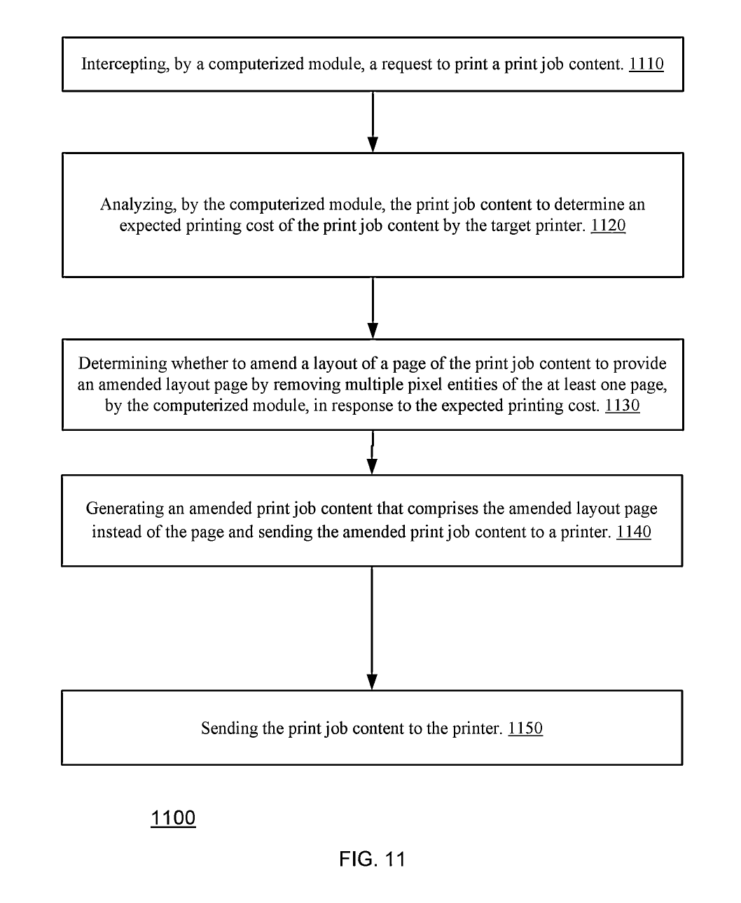

FIG. 11 illustrates method 1100 for managing a print job, according to an embodiment of the invention.

Method 1100 may start by stage 1110 of intercepting, by a computerized module, a request to print the print job content.

Stage 1110 may be followed by stage 1120 of analyzing, by the computerized module, the print job content to determine an expected printing cost of the print job content by the target printer.

Stage 1120 may be followed by stage 1130 of determining whether to amend a layout of a page of the print job content to provide an amended layout page by removing multiple pixel entities of the at least one page, by the computerized module, in response to the expected printing cost.

If it determined to amend the layout then stage 1130 may be followed by stage 1140 of generating an amended print job content that comprises the amended layout page instead of the page and sending the amended print job content to a printer.

If it determined to not to amend the layout then stage 1130 may be followed by stage 1150 of sending the print job content to the printer.

Stage 1140 may include removing multiple pixel entities that a cost of their printing is higher than an allowed.

Stage 1140 may include generating output information representative of a reduced consumable image in response to consumable smear, spatial relationship between adjacent dots and image quality degradation.

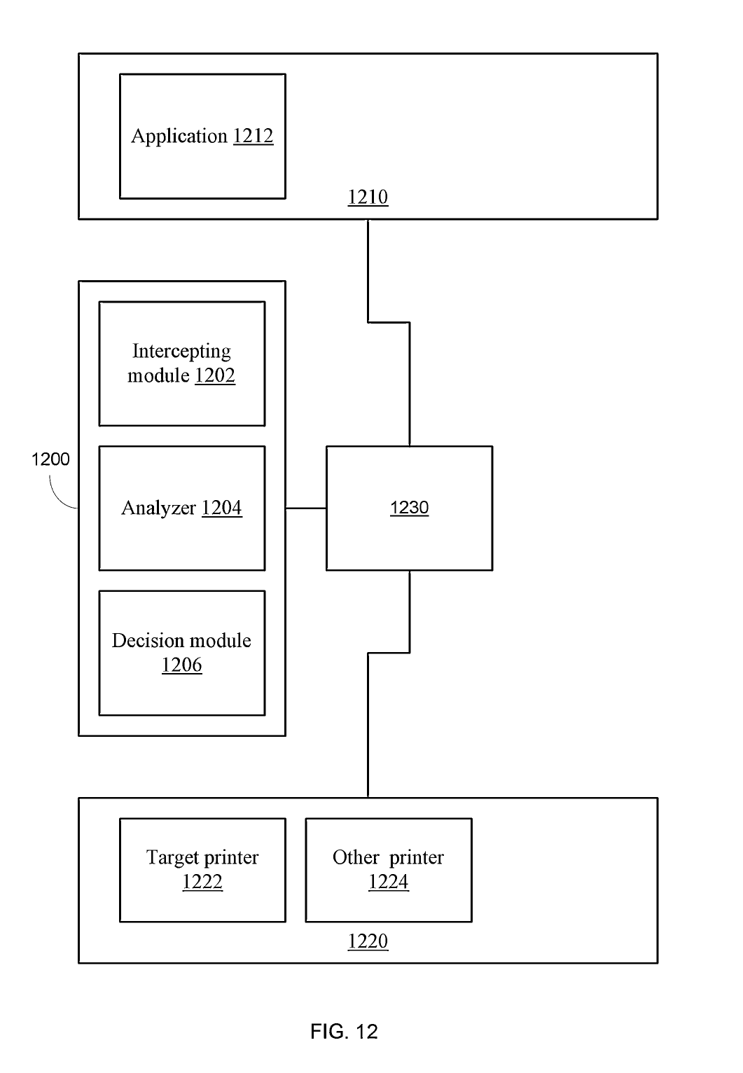

FIG. 12 illustrate a system 1200 and its environment according to an embodiment of the invention.

The system 1200 may include intercepting module 1202, analyzer 1204, and decision module 1206. Each one of these modules (1202, 1204 and 1206) or a combination of one or more of these modules can be regarded as a computerized entity.

The interceding module 1202 may be arranged to intercept a print job (a request to print a print job content).

The request can be send from a requesting entity such as application 1212 out of a group of possible requesting entities 1210. The requesting entities may include an application hosted by a computer, a computer, a mobile device and the like. The print job can indicate a target printer such as printer 1022 out of group 1020 of printers. The group of printers 1020 may include at least one other printer such as other printer 1224. The printers of group 1020 may be monochromatic printers, color printers, printers of different quality and/or cost of printing, virtual and physical printers and the like.

The group of printers 1220, system 1200 and possible requesting entities 1210 (or the computers that host requesting entities 1210) may be coupled to each other via network 1230.

The analyzer 1204 can be arranged to analyze the print job content to determine an expected printing cost of the print job content. The analysis can be responsive to the target printer.

The decision module 1206 may be arranged to select a selected printer to print the print job content, out of the target printer and another printer, in response to the expected printing cost; and send the print job content information to the selected printer.

According to another embodiment of the invention the intercepting module 1202 is arranged to intercept a request to print a print job content. The analyzer 1204 is arranged to analyze the print job content to determine an expected printing cost of the print job content by the target printer. The decision module 1206 is arranged to determine whether to amend a layout of a page of the print job content to provide an amended layout page by removing multiple pixel entities of the at least one page, by the computerized module, in response to the expected printing cost. Wherein if it determined to amend the layout then the decision module 1206 may be arranged to generate an amended print job content that comprises the amended layout page instead of the page and sending the amended print job content to a printer. Wherein if it is determined not to amend the layout then the decision module 1206 may be arranged to send the print job content to the printer.

According to another embodiment of the invention the intercepting module may be arranged to intercept a request to print a print job content that comprises monochromatic pixels and color pixels, the request comprises print job content. The analyzer 1204 may be arranged to analyze the print job content to determine at least one printing parameter selected out of (a) a ratio between color pixels and monochromatic pixels composition of the print job content, and (b) an expected printing cost of the print job content. The decision module 1206 may be arranged to determine whether to print the print job content as a monochromatic print job content or as a color print job content; wherein the selecting is responsive to the at least one printer parameter; and send to a printer instructions to print the print job content according to the determination.

The invention may also be implemented in a computer program for running on a computer system, at least including code portions for performing steps of a method according to the invention when run on a programmable apparatus, such as a computer system or enabling a programmable apparatus to perform functions of a device or system according to the invention.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

Any system, apparatus or device referred to this patent application includes at least one hardware component.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

The present invention can be practiced by employing conventional tools, methodology and components. Accordingly, the details of such tools, component and methodology are not set forth herein in detail. In the previous descriptions, numerous specific details are set forth, such as shapes of test structures and materials that are electro-optically active, in order to provide a thorough understanding of the present invention. However, it should be recognized that the present invention might be practiced without resorting to the details specifically set forth.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

What is claimed is:

1. A method for managing a print job, the method comprising:
intercepting, by a computerized module, a request to print a print job content by a target printer;
analyzing, by the computerized module, the print job content to determine an expected printing cost of the print job content by the target printer;
selecting, by the computerized module, a selected printer to print the print job content, out of the target printer and another printer, in response to the expected printing cost and statistics of previously printed print job contents; and
sending the print job content information to the selected printer.

2. The method according to claim 1, comprising determining to print the print job content by the other printer if an expected printing cost of the print job content by the other printer is lower than the expected printing cost of the print job content by the target printer.

3. The method according to claim 1, wherein the other printer is a monochromatic printer and the target printer is a color printer.

4. The method according to claim 1, further comprising, determining, by the computerized module, whether to modify the print job content to provide modified print job content that represents a modified print job content that is expected to be cheaper to print than the print job content; and sending the modified print job content to the selected printer.

5. The method according to claim 1 further comprising determining whether to select a selected printer or to prevent the printing if the expected printing cost of the print job content by the target printer exceeds a cost threshold.

6. The method according to claim 1 further comprising determining whether to select a selected printer or to prevent the printing if an expected printing cost of the print job content by any printer out of the target printer and the other printer exceeds a cost threshold.

7. The method according to claim 1 wherein the other printer is a virtual printer arranged to convert the print job content to a digital print job content.

8. The method according to claim 1, wherein the intercepting occurs before the request reaches the target printer.

9. The method according to claim 1, wherein the analyzing comprises determining a layout of the print job content, types of content and color composition.

10. The method according to claim 1, wherein the analyzing comprises calculating a cost for printing each text symbol of the print job content by evaluating a size and shape of the text symbol and a manner in which the target printer is expected to print the text symbol.

11. The method according to claim 1, further comprising, determining, the computerized module, whether to modify the print job content to provide modified print job content that represents a modified print job content; modifying the print job content to provide the modified print job content; and sending the modified print job content to the selected printer.

12. The method according to claim 1, further comprising preventing the printing of the print job content if detecting a key word that indicates that the document should not be printed.

13-29. (canceled)

30. A computer readable medium having stored thereon a set of instructions, the set of instructions, when executed by a processor, cause the processor the perform a method of: intercepting a request to print a print job content by a target printer; analyzing, by the processor, the print job content to determine an expected printing cost of the print job content by the target printer; selecting, by the processor, a selected printer to print the print job content, out of the target printer and another printer, in response to the expected printing cost and statistics of previously printed print job contents; and sending the print job content information to the selected printer.

31. (canceled)

32. The method according to claim 11, wherein the modifying is responsive to a layout, text, image content and a coverage of the print job content.

33. The method according to claim 11, wherein the modifying comprises amending a layout of a page of the print job content by removing multiple pixel entities of the page, by the computerized module.

34. The method according to claim 11, further comprising modifying the print job content by removing at least one image from the print job content.

35. The method according to claim 11, further comprising modifying the print job content by removing at least one out of a header and a footer from the print job content.

36. The method according to claim 1 wherein the other printer is a monochromatic printer and the target printer is a color printer; and wherein the selecting, by the computerized module, of the selected printer is responsive to a ratio between monochromatic and color pixels.

37. The method according to claim 1 wherein the statistics of the previously printed job contents comprises printing applications associated with the previously printed job contents.

38. The method according to claim 1 wherein the statistics of the previously printed job contents comprises printing applications associated with the previously printed job contents.

39. The method according to claim 1 wherein the statistics of the previously printed job contents comprises key words associated with the previously printed job contents.

39. The method according to claim 1 wherein the statistics of the previously printed job contents comprises at least one out of total coverage, monochromatic coverage, color coverage, image coverage, graphic coverage and text coverage associated with the previously printed job contents.

40. The method according to claim 1 wherein the statistics of the previously printed job contents comprises at least one out of total coverage per page, monochromatic coverage per page, color coverage per page, image coverage per page, graphic coverage per page and text coverage per page associated with the previously printed job contents.
